(19) United States
(12) Patent Application Publication
(10) Pub. No.: US 2008/0081125 A1
(43) Pub. Date: Apr. 3, 2008

(54) Method for manufacturing cover lay of printed circuit board

(75) Inventors: Hyun-Chul Jung, Yongin-si (KR); Jae-Woo Joung, Suwon-si (KR); Hye-Jin Cho, Seoul (KR); Yoon-Ah Baik, Suwon-si (KR); Sung-Il Oh, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/902,486

(22) Filed: Sep. 21, 2007

(30) Foreign Application Priority Data
Oct. 2, 2006 (KR) 10-2006-0097436

(51) Int. Cl. C23C 18/00; H05H 1/00

(52) U.S. Cl. 427/553; 427/98.4

(57) ABSTRACT

A method for manufacturing cover lay of printed circuit board is disclosed. With a method that includes preparing a board on which a circuit pattern is formed, and jetting a protecting ink selectively on the board by inkjet printing, a cover lay of a complicated shape may be formed easily with high accuracy and high productivity, as a polymer ink is jetted by inkjet printing to form the cover lay for a flexible circuit board.

### CROSS-REFERENCE TO RELATED APPLICATIONS

This application claims the benefit of Korean Patent Application No. 10-2006-0097436 filed with the Korean Intellectual Property Office on Oct. 02, 2006, the disclosure of which is incorporated herein by reference in its entirety.

### BACKGROUND

1. Technical Field

The present invention relates to a method for manufacturing a cover lay of a printed circuit board.

2. Description of the Related Art

A printed circuit board is manufactured by forming a circuit pattern on a CCL (copper clad laminate) consisting of a polymer resin and a copper film joined with the polymer resin by a photo-lithography process. A cover lay is formed in order to protect the circuit pattern, by forming a thin film on the surface of the circuit pattern with a photo-sensitive resin and performing exposure and development.

Recently, the use of the flexible circuit board is increasing in fields requiring flexibility. A flexible circuit board is manufactured using a FCCL (flexible copper clad laminate), which consists of a copper film, to which a polymer resin is joined that has high thermal resistance and high flexibility, such as a polyimide, instead of epoxy resin used in a typical rigid circuit board. The circuit pattern is formed by a photo-lithography process for the FCCL as well, with the circuit pattern protected by a protecting layer referred to as a cover lay.

A cover lay consists of a polyimide and an adhesive joined with the polyimide, and is attached to a flexible circuit board by hot pressing. The flexible circuit board is often used in products requiring flexibility, and is often applied to curved shapes and other various forms.

Currently, the cover lay is attached to a flexible circuit board by pre-attaching after forming the shape of the product and then laminating with heat. However, because most of these processes are done by hand, there is low efficiency, as well as low accuracy and low productivity.

FIG. 1A to 1D are cross-sectional views of a cover lay according to prior art. In FIG. 1A to 1D are illustrated a polyimide film 1, an adhesive layer 2, a board 3, a circuit pattern 4, a pad 5 for mounting a device and an open terminal part 6.

Referring to FIG. 1A to 1D, a cover lay according to prior art may consist of a polyimide film 1 and an adhesive layer 2. A polyimide film of 12.5 μm˜25 μm is generally used. A thermosetting resin, such as an epoxy resin, may be used as the adhesive layer. The thickness of the adhesive layer may be changed according to the thickness of the circuit pattern, such that the adhesive layer fills up the etched portions.

The portion 5 for mounting a device or for connecting circuit patterns is not covered by the cover lay. This part, referred to as a “window” is formed by punching the cover lay.

The cover lay may be attached to a flexible circuit board by hot pressing after aligning the window to the flexible circuit board and pre-attaching the edges. This can be very time-consuming, because the aligning and the pre-attaching are done by hand, and can result in lower quality of the product.

### SUMMARY

An aspect of the invention is to provide a method for manufacturing a cover lay of a printed circuit board that offers high accuracy and high productivity, by jetting a polymer ink with an inkjet head to form the cover lay for a flexible circuit board.

One aspect of the invention provides a method for manufacturing a cover lay of a printed circuit board which includes preparing a board on which a circuit pattern is formed, and jetting a protecting ink selectively on the board by inkjet printing.

An operation of filtering the protecting ink may further be included before jetting the protecting ink to the board, and the protecting ink may be made of at least one material selected from a group consisting of polyimide, epoxy resin, polyacrylate and polyurethane.

An operation of hardening the protecting ink may further be included after the jetting of the protecting ink to the board, and the hardening may be done by supplying heat or ultraviolet rays to the protecting ink.

Additional aspects and advantages of the present invention will become apparent and more readily appreciated from the following description, including the appended drawings and claims, or may be learned by practice of the invention.

### BRIEF DESCRIPTION OF THE DRAWINGS

FIG. 1A to 1D are cross-sectional views of a cover lay according to prior art.

FIG. 2 is a flowchart illustrating a method for manufacturing a cover lay according to an embodiment of the invention.

FIG. 3 is a cross-sectional view illustrating a process for manufacturing a cover lay according to an embodiment of the invention.

FIG. 4 is a cross-sectional view of a piezoelectric type inkjet head.

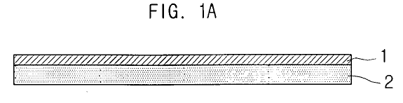

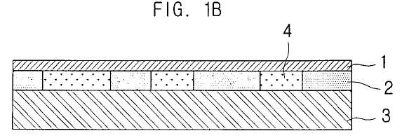

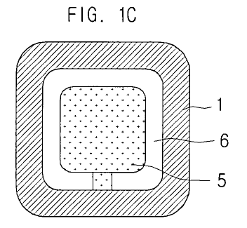

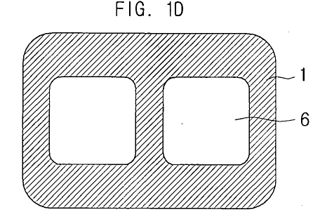

### DETAILED DESCRIPTION

Certain embodiments of a method for manufacturing a cover lay of a printed circuit board according to the invention will be described below in more detail with reference to the accompanying drawings. In the description with reference to the accompanying drawings, those components are rendered the same reference numeral that are the same or are in correspondence regardless of the figure number, and redundant explanations are omitted.

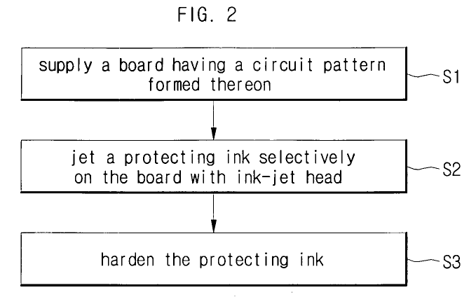

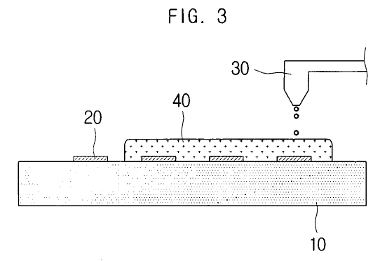

FIG. 2 is a flowchart illustrating a method for manufacturing a cover lay according to an embodiment of the invention, and FIG. 3 is a cross-sectional view illustrating a process for manufacturing a cover lay according to an embodiment of the invention. In FIG. 3 are illustrated a board 10, a circuit pattern 20, an inkjet head 30 and a protecting ink 40.

First, a board 10 on which a circuit pattern 20 is formed may be prepared (S1). The circuit pattern 20 may be formed on the board 10, where the circuit pattern 20 may serve to deliver electrical signals. The cover lay may be formed to protect this circuit pattern 20.

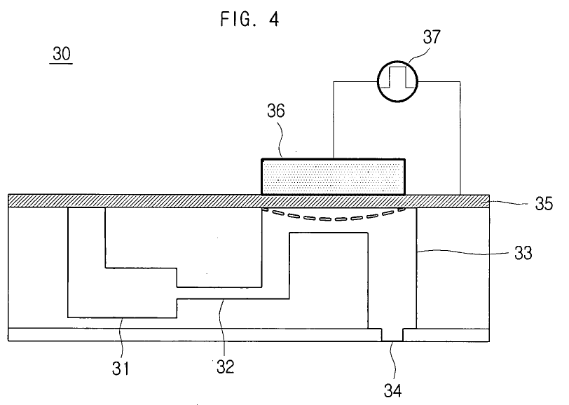

Next, a protecting ink 40 may be jetted selectively on the board 10 by an inkjet head 30 (S2). Before describing this operation in further detail, the inkjet head 30 used in this embodiment will be described below referring to FIG. 4.

FIG. 4 is a cross-sectional view of a piezoelectric type inkjet head 30. In FIG. 4 are illustrated a reservoir 31, a restrictor 32, a chamber 33, a nozzle 34, a vibration plate 35, a piezoelectric element 36 and a power supply 37.

The reservoir 31 may contain the protecting ink 40, and provide the protecting ink 40 to the chamber 33 through the restrictor 32.

The restrictor 32 may serve as a channel that connects the chamber 33 with the reservoir 31, and provide the protecting ink 40 to the chamber 33 from the reservoir 31. The restrictor 32 may be formed with a cross-sectional area smaller than that of the reservoir 31. Also, the restrictor 32 may control the amount of ink provided from the reservoir 31 to the chamber 33 when the vibration plate 35 is made to vibrate by the piezoelectric element 36.

The chamber 33 may be connected with the reservoir 31 by the restrictor 32. Moreover, the side of the pressure chamber 33 that is not connected with the restrictor 32 may be connected with the nozzle 34. Therefore, the chamber 33 may receive the protecting ink 40 from the reservoir 31 and provide the protecting ink 40 to the nozzle 34, whereby printing may take place.

One side of the chamber 33 may be covered by the vibration plate 35, and the piezoelectric element 36 may be joined on the upper side of the vibration plate 35 in correspondence to the location of the chamber 33.

The piezoelectric element 36 may be joined on the upper side of the vibration plate 35 in correspondence to the location of the chamber 33, and may generate vibrations. The piezoelectric element 36 may supply a driving pressure to the chamber 33 by receiving electrical power from the power supply 37 and generating the vibration.

The nozzle 34 may be connected with the chamber 33, and may receive the protecting ink 40 from the chamber 33 and jet the protecting ink 40. When a vibration generated by the piezoelectric element 36 is provided to the chamber 33 through the vibration plate 35, a pressure may be supplied to the chamber 33, at which the nozzle 34 may jet the protecting ink 40 by the pressure.

While the inkjet head 30 of a piezoelectric type having the structure described above is illustrated for describing this embodiment with reference to FIG. 4, it is apparent that various other kinds of inkjet head may be applied besides the inkjet head 30 described above, according to the requirements of the designer or user.

The protecting ink 40 may be jetted on the board 10 on which the circuit pattern 20 is formed, and form a cover lay after hardening. The protecting ink 40 may be made of a polyimide, epoxy resin, polyacrylate or polyurethane, or combinations thereof. In addition, it is apparent that various other kinds of material suitable for the inkjet head 30 may be applied as necessary. In this embodiment, a polyimide is presented as an example of the protecting ink 40.

A polyimide is a polymer having an imide group in its main chain. Polyimides have the mechanical features of high compressive strength, high impact resisting strength and high tensile strength, and electrical features of low permittivity and high electric resistance. Also, polyimides have high thermal resistance, high resistance to oxidation at high temperatures, high chemical resistance and low rates of thermal expansion.

The protecting ink 40 may be formed by dispersing a polymer such as a polyimide in a solvent, or dispersing monomers of a polymer in a solvent. The protecting ink 40 may itself be made of monomers.

A protecting ink 40 formed by dispersing monomers or polymers in a solvent may have low viscosity and thus may be suitable for jetting. This has the merit of simplifying the manufacturing process, because evaporation and polymerization of the solvent may occur after the jetting. In addition, a cover lay formed from a protecting ink 40 made of monomers may be over 10 μm and may provide high adhesion and high strength.

As described above, the form of the protecting ink 40 may be changed according to the requirements of the designer or user.

Before jetting the protecting ink 40 by inkjet printing, the protecting ink 40 may be filtered to eliminate particles of excessively large sizes that may block the nozzle 34 of the inkjet head 30.

Also, cleaning or surface treatment may be performed on the board 10 to enhance adhesion and control the contact angle. The washing may be performed by any of a variety of methods, such as by removing pollutants with an organic solvent or an alkali cleaning solution, by etching with acidic materials such as a chromic acid, sulphuric acid or hydrochloric acid, by shot blasting, by anodizing, or by eliminating a pollutant with ions or plasma. The cleaning may also be performed by other commonly known methods for eliminating pollutants.

To enhance adhesion between the board 10 and the protecting ink 40, an adhesion improver may be applied on the board 10 before jetting the protecting ink 40.

Then, the filtered protecting ink may be jetted on the board 10 by inkjet printing.

Next, the protecting ink 40 may be hardened (S3). This is because the protecting ink 40 jetted on the board 10 for forming a cover lay may be a liquid or a paste and thus may need to be hardened in order to serve as a cover lay protecting the circuit pattern 20.

Supplying heat or UV (ultraviolet) rays may be presented as a method for hardening the protecting ink 40. Specifically, if the protecting ink 40 includes a polymer dispersed in a solvent, the protecting ink 40 may be hardened by evaporating the solvent using a thermal treatment at 200° C. for 30 minutes. Also, if the protecting ink 40 includes monomers dispersed in a solvent or monomers themselves, the protecting ink 40 may be hardened by polymerizing the monomers by supplying heat or UV rays to the protecting ink 40.

According to the present invention comprised as above mentioned, a cover lay of a complicated shape may be formed easily with high accuracy and high productivity, by jetting a polymer ink by inkjet printing to form the cover lay for a flexible circuit board.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A method for manufacturing a cover lay of a printed circuit board, the method comprising:
preparing a board having a circuit pattern formed thereon; and
jetting a protecting ink selectively on the board by inkjet printing.

2. The method of claim 1, further comprising filtering the protecting ink before the jetting.

3. The method of claim 1, wherein the protecting ink is made of at least one material selected from a group consisting of polyimide, epoxy resin, polyacrylate and polyurethane.

4. The method of claim 1, further comprising hardening the protecting ink after the jetting.

5. The method of claim 4, wherein the hardening is performed by supplying heat or ultraviolet rays to the protecting ink.
